(19) United States
(12) Patent Application Publication
(10) Pub. No.: US 2015/0242405 A1
(43) Pub. Date: Aug. 27, 2015

(54) METHODS, DEVICES AND SYSTEMS FOR CONTEXT-SENSITIVE ORGANIZATION OF MEDIA FILES

(71) Applicant: Sony Corporation, Tokyo (JP)

(72) Inventors: Tom HOSTYN, Halle (BE); Chris MINNOY, Holsbeek (BE); Kenny HELSENS, Gent (BE); Gerard MAAS, Edegem (BE); Murat Burak MIGDISOGLU, Antwerpen (BE); Michel TILMAN, Ninove (BE); Jan SPOOREN, Schoten (BE); Philip MARIVOET, Tienen (BE); Teemu Veikko Tapani POHJOLA, Rovaniemi (FI); Magdalena WASOWSKA, Kessel-Lo (BE); Conor AYLWARD, Brussels (BE); Olivier DEMARTO, Sint-Gillis (BE); Gaetan DE BRUCKER, Aalst (BE); Joachim GIARD, Hevillers (BE)

(73) Assignee: Sony Corporation, Tokyo (JP)

(21) Appl. No.: 14/627,388

(22) Filed: Feb. 20, 2015

(30) Foreign Application Priority Data
Feb. 26, 2014 (EP) 14156765.1

(51) Int. Cl. G06F 17/30

(52) U.S. Cl. CPC G06F 17/3053; G06F 17/30867; G06F 17/30256; G06F 17/30825; G06F 17/30029; G06F 17/30528; G06Q 50/01

(57) ABSTRACT

It is described a method determining context information of at least one media file stored in a media storage, and matching reference context information with the context information to determine at least one context-matching media file.

The disclosure relates to methods, devices, systems and services for context-sensitive organization of media files.

### BACKGROUND

Today, users of electronic devices are producing a huge number of media files such as photos and videos. Such media files are produced with a lot of different devices, e.g. point-and-shoot cameras, digital single-lens reflex (DSLR) cameras, mobile phone cameras, video cameras, wearable computing devices (glasses), etc.

Such electronic devices may be connected to communication systems and thus allow the user to upload pictures to photo and video storing services immediately after capture or later after having been transferred to a PC. Today even point-and-shoot cameras, DSLR cameras, and video cameras may be provided with WI-FI and/or UMTS or LTE transceivers which allow the user to connect with the Internet in order to upload photos and videos to cloud storages and share photos and videos in cloud services.

With the increasing popularity of cloud services in the past years, Internet-based photo and video storing and sharing services have become widely used by private and professional users throughout the world. Photo and video storing services provide the users with data storage capacity for storing photo and video collections comprising thousands of photos and videos taken over years. Such photo and video storing services typically provide the user with the capability of sharing photos and videos with family and friends and presenting photos and videos on the screen of a computing device, or sharing them with the public. In social networks, within one family or group of friends, many pictures are taken and shared by different members of that group.

### SUMMARY

In the light of this, an object of the disclosure is to provide users of electronic devices with new or improved services.

Methods, devices, and systems for context-sensitive organization of media files are disclosed and defined in the appended set of claims.

### BRIEF DESCRIPTION OF THE DRAWINGS

Details of the disclosed methods, devices and systems will become more apparent from the following description of embodiments in connection with the accompanying drawings, of which

FIG. 1 schematically shows an embodiment of a system for context-sensitive organization of media files; in this embodiment a cloud service and respective method for providing a ‘see-through’ camera mode is provided;

FIG. 2 schematically shows an embodiment of a method for context-sensitive organization of media files in correspondence with the system of FIG. 1;

FIG. 3 schematically shows an image matching process which is used in generating reference context information from a reference image;

FIG. 4 schematically shows an embodiment of the matching of reference context information with context information of a media file from a media store;

FIG. 5 schematically shows a further embodiment of a system for context-sensitive organization of media files; in this embodiment a cloud service and respective method for automatically generating media albums is provided;

FIG. 6 schematically shows an embodiment of a method for context-sensitive organization of media files in correspondence with the system of FIG. 5;

FIG. 7 schematically shows a further embodiment of a system for context-sensitive organization of media files; in this embodiment a cloud service and respective method for providing a semantic media search is provided;

FIG. 8 schematically shows an embodiment of a method for context-sensitive organization of media files in correspondence with the system of FIG. 7; and

FIG. 9 schematically shows an embodiment of an electronic device for use with the above-described context-enhanced cloud services.

### DETAILED DESCRIPTION OF THE EMBODIMENTS

Aspects of embodiments of methods, apparatus and systems for context-sensitive selection of media files are now described.

The behavior of taking pictures has changed since analog times. Today, as picture and video taking does not require purchasing photographic films, users take many pictures of one ‘shot’ just to make sure that at least one is good. Afterwards they select or share the best one. Further, consumers use photography as a way to remember things in a very utilitarian way, e.g. by taking a picture of a wine bottle to buy it later, by taking a picture of a street name to remember where the car is parked, or by taking a picture of a whiteboard during a meeting to help making notes. Some pictures have emotional value to the user, many don't.

Because so many media files are produced, it is a tedious job to organise the collected media files and to choose the best pictures or films, e.g. of a particular event, trip, or period. Automating this job will enhance products and services. Such automation benefits of context information associated with media files. Today, mobile devices such as cameras, tablets and mobile phones may for example comprise GPS sensors which allow photos and videos to be tagged with geographic coordinates which represent the location at which a photo or video was taken and thus allow to associate the captured media files with context. Other information about context may be obtained for example directly from the user of the device who tags photos with keywords or provides photos with descriptions. Other possible sources of context in formation which may be beneficial for organizing the huge amount of media files produced every day are disclosed below.

A method for context-sensitive organization of media files may comprise determining context information of at least one media file stored in a media storage, and matching reference context information with the context information to determine at least one context-matching media file. The method may for example be used to organize media files stored in a cloud storage, on a social website, on a mobile device like a camera, tablet, or notebook, or on desktop computers.

Organizing media files may comprise arranging media files according to a given context for viewing. Organizing media files may also comprise a context-sensitive selection of media files for sharing them with other persons. Further, organizing media files may also comprise searching and/or filtering media files according to a given context, or the like.

Context information may be any information which allows to relate a media file with a context. This might for example be metadata obtained by a camera device when taking a photo and stored in a graph database. The context information might however also be of a more implicit nature, for example information about activity on social sites related to a media file. More examples and details are given below. The reference context information may be used in a matching process as counterpart to media file related context information in order to determine context-matching media files. The context information may for example be used to select or organize media files according to a users or systems needs.

The matching process may relate reference context information to the media file related context information and may be used to determine how good a media file matches with a given reference context. The matching process may for example involve comparing words, parameters, or the like.

The matching process may also comprise other comparison tools like image recognition or semantic comparisons.

A method for context-sensitive organization of media files may further comprise rating the context-matching media files by means of a rating algorithm to determine best-matching media files. The rating of the context-matching media files may be based on parameters obtained in the matching process which describe the degree of matching between a media file and the reference context information. Alternatively or in addition the rating may involve parameters related to the quality of a media file, or parameters related to the popularity of a media file on a social website. The rating of the context-matching media files may happen during the matching process, or later, after the matching process.

In a method for context-sensitive organization of media files, rating the context-matching media files may further comprise rating the context-matching media files based on parameters related to the quality of a media file. For example a quality estimation algorithm might determine if a photo is sharp or blurry. A sharp photo may be rated higher than a blurry photo. In addition or alternatively a quality estimation algorithm might determine if a photo is well exposed, over-exposed or underexposed. Well exposed photos may be rated higher than photos which are over-exposed or underexposed. In addition or alternatively a quality estimation algorithm might determine the ISO noisiness of a photo. Photos with low or absent ISO noise may be rated higher than photos with high noise. In the case of videos, rating the context-matching media files might comprise determining the amount of camera shake in the video. A video with a low amount of camera shake may for example be rated better than images with a high amount of camera shake.

In a method for context-sensitive organization of media files, the reference context information may for example be obtained by performing image matching between a reference media file obtained from an electronic device and the media files, and by determining the reference context information based on the context information of the obtained image-matching media file. The reference media file may for example be a still image captured by an electronic device. This may allow to define a reference context by pointing a camera to an object or scenery, to capture an image of the object or scenery, and to use the captured image as basis for reference context information in selecting context-matching media files from a media store, which match the context of the captured image.

The reference information thus obtained may be matched with context information of media files stored in the media storage to determine context-matching media files. The context-matching media files may also be rated by means of a rating algorithm to determine best-matching media files.

In a method for context-sensitive organization of media files a best-matching video file may be selected from best-matching media files based on the rating obtained by the rating algorithm.

A method for context-sensitive organization of media files may further comprise rendering the selected best-matching video file on the electronic device in place of a reference image in such way that it appears to the user of the electronic device like the video file is playing in the physical frame containing the reference image. The best-matching video file may for example be streamed or otherwise transmitted to the electronic device.

A method for context-sensitive organization of media files may further comprise rating the context-matching media files by means of a rating algorithm to determine best-matching media files, and generating a media album from the best-matching media files.

In a method for context-sensitive organization of media files the reference context information may for example comprise personal profile information, and the matching reference context information with context information of media files stored in the media storage may comprise matching personal profile information with context information of media files. This may allow to generate specific albums or presentations by knowing who it will be shared with. For example, sharing with a specific person could show only photos that this person is interested in, focussing about people this person cares about, and events this person shared, or this person's known interests.

Personal profile information may for example be personal information available for a specific person on a social website, like name, age, gender, hobbies, relationships, likes, etc. In addition or alternatively the personal profile information might be information retrieved from an electronic address book stored on an electronic device or in the cloud. Rating the context-matching media files may comprise rating the context-matching media files based on parameters related to the quality of a media file.

In a method for context-sensitive organization of media files the reference context information may for example comprise semantic search information, and the matching reference context information with context information of media files stored in the media storage may comprise matching semantic search information with context information of media files.

In a method for context-sensitive organization of media files the determining context information of media files stored in a media storage may comprise determining meta information such as location information, time information, rating information, privacy levels, media descriptions, media tags, information about the producer of a media file, preference information, or information about camera settings.

The time of a photo capture is typically known by the camera device and stored as metadata alongside with the image data or in a separate context database, for example as data in the Exchangeable Image File Format (Exit) which is stored within a JPG or TIFF image file. The location of the photo capture may be known if a camera device comprises a GPS sensor. A camera device may also be aware of who is taking the picture. A mobile phone operating system may for example be associated with an email account, and/or other accounts such as accounts of social websites, which allow to determine who is using a device. The time and location together with the users calendars or social actions (social events, calendar appointments, and the like) can be used to establish an understanding of ‘what’ the picture is about. Such information may also be used to determine who else is present in an event. E.g. at a dinner party, five people may be present according to information on social websites, but only two may be visible in a picture. Such information may be used to describe in the context information of a media file who is in the picture, and who is present at the associated event, but not in the picture. Information about time and location may also be used to determine if an event at which a media file was captured is a business or fun event.

Further, information about time and location together with information from a users calendars or social actions might be used to group different pictures taken by different devices to the same event, or it can be used to group different pictures taken by different people to the same event. The grouped pictures may then be used as a meaningful entity by the album creation as, for example, an entry point by creating an album from an identified event, or as possible limitation, e.g. by determining that at most three pictures shall be taken from each identified event.

In addition or alternatively, in a method for context-sensitive organization of media files the determining context information of media files stored in a media storage may comprise determining information about the sharing of the media files on social sites. The fact that a photo is shared may for example be used as an indication that the shared photo is a meaningful photo and such information may be used when rating a photo. Details of how, when and where a photo was shared may be recorded in the context information of a media file. Further, when on a social website photos are commented upon, are liked, are tagged, or the like, the number of comments, likes, tags etc. may be counted and the result may be stored as context information of the media file. Also emotional response of these comments and likes may be estimated using language engines and may be added to the context information of the associated media file.

In addition or alternatively, in a method for context-sensitive organization of media files the determining context information of media files stored in a media storage may comprise determining information about the sharing of the media files in real life. In real life, camera devices, mobile phones, tablet computers, televisions, etc. are used for showing media files to friends or family. Many of such devices have a front facing camera and a microphone. These can be used to estimate the emotional response as well as the identity of the persons viewing the picture. Information about the identity of the persons and their emotional response may be added to the context information of a media file. Also, the number of ‘real world’ shares may be captured in the context information and used when rating a media file.

In addition or alternatively, in a method for context-sensitive organization of media files the determining context information of media files stored in a media storage may comprise determining information about the mood of the person who produced a media file. Mobile phones, tablets have a front and rear facing camera. While one camera will be used to capture the desired picture, the other can be used to capture the person taking the picture. This can be used to determine their identity but also their mood. A person taking an emotional meaningful picture, e.g. of its child, is expected to show emotion by smiling. A person taking a snapshot of a whiteboard during a meeting may have a neutral expression. The front and rear facing cameras may also give additional context information about the location or time. A microphone can capture the mood of the place (tranquil, noisy, party, . . . ). Biometric devices like bracelets and glasses can monitor the heartbeat, pupil dilation, etc. to estimate the mood of the viewer or photographer during the picture taking event. The thus obtained information can be added to the context information of a media file.

In a method for context-sensitive organization of media files the determining context information of media files stored in a media storage may comprise recognizing features of the content of a media file and determining information about such recognized features. Landmarks may be visible in a picture. Such landmarks may be recognized using vision technology, helped with the GPS coordinates and direction of the camera. The landmarks may be compared with a database of landmarks. If a landmark, such as the Eiffel tower for example, is visible, this information may be added to the context information of a picture.

Some or all of the above-described context information may be used as context information for media files stored in a media storage. Such information may be matched with reference context information and may be used to generate a ranking of media files according to their meaningfulness to the reference context information and, optionally, according to their inherent quality. After ranking the context-matching media files, a predefined number, for example ten of the highest ranking pictures may be taken into an automatically generated album. An automatically generated album can then be view on an electronic device, shared using social media or can be sent to a print shop to make a booklet.

A method for context-sensitive organization of media files may further comprise determining a contextual relationship between the media files stored in the media storage. For example, captured media from different sources may be uploaded to a media storage system. During or after the upload of the media, the media files may be analyzed, creating a contextual relationship graph of the different media files based on, but not limited to image content, location information and time information as well as any additional input provided by the owner of said media (such as privacy levels, rating and preferences). The contextual information which makes up the contextual relationship graph may then be stored in a context store, which could e.g. be a graph database, for later access of content-related media files. Such a graph database may be a database that uses graph structures with nodes, edges, and properties to represent and store the context data. Use of a graph database may provide index-free adjacency, which means that every element contains a direct pointer to its adjacent elements so that no index lookups are necessary. For example, a picture may be connected to the photographer, the location, the people appearing in the picture, or even the state of the weather when taking the picture. E.g., by ‘walking this graph’, one can start with one picture, find its connected location and then enumerate over all other pictures for this location. Similarly, one may find pictures taken by the same photographer, or during the same weather conditions, by ‘walking this graph’ of media content nodes, connected by context nodes. In this way, in the case that a specific media file is found to match the reference context, other media files which are related to this media file by virtue of the context relationship graph may be judged to be of relevance, too.

In a method for context-sensitive organization of media files the context information and the media files may be stored in a cloud storage. The context information may for example be stored alongside the media files in the same data repository as the media files, or in a context store which provides for example a graph database. The context information for each picture stored in the cloud might dynamically evolve throughout the picture lifetime, for example if further ‘shares’ or ‘likes’ are produced on a social website.

During a presentation of an automatically generated album, the viewers may be given the possibility to indicate that they want to see ‘more like this’ or ‘less like this’. Such information might be used in a further ranking and presentation of context-matching media files.

The above-described methods may be offered as an engaging user experience on a mobile device or website.

A cloud server system (or cloud service) for context-sensitive organization of media files may comprise a media storage configured to store at least one media file, a context unit configured to determine context information of the at least one media file, and a recognition unit configured to match reference context information with the context information to determine at least one context-matching media file. The cloud server system (or cloud service) may be configured to perform the methods for context-sensitive organization of media files as described above.

The media storage may be a central storage, or a distributed storage. The media storage may be a cloud storage, for example a personal media storage of a family or the like.

The context unit and the recognition unit may be implemented as software running on computer hardware, such as server computers, or server farms. The hardware may be centralized or distributed.

The cloud service might be implemented in or might make use of a controller of an electronic device. The controller may run an application program which is installed or downloaded to the electronic device.

An electronic device for context-sensitive organization of media files may comprise a display and a controller, the controller being configured to determine reference context information, to receive at least one context-matching media file which has been obtained by matching the reference context information with context information of at least one media file, and to render the at least one context-matching media file on the display. The electronic device may be a mobile device, such as a mobile phone, tablet computer, camera device or notebook computer, or the electronic device might be a desktop computer or workstation.

In an electronic device for context-sensitive organization of media files, a controller may be configured to upload the reference context information to a cloud server system, and to receive the at least one context-matching media file from the cloud server system, the received at least one context-matching media file being context-matched by the cloud server system with the reference context information uploaded by the uploading unit.

In an electronic device for context-sensitive organization of media files, a controller may be configured to render a video on the display in place of a reference image in such way that it appears to the user of the electronic device like the video is playing in the physical frame containing the reference image.

In addition or alternatively, in an electronic device for context-sensitive organization of media files, a controller may be configured to determine reference context information by receiving semantic search information from keyboard input. The controller might for example present a search field to the user. The user may use a conventional keyboard or a touch screen keyboard to enter search terms in order to define a semantic search pattern.

In addition or alternatively, in an electronic device for context-sensitive organization of media files a controller may be configured to determine reference context information from personal profile information. The personal profile information might for example be retrieved from an address book available on the electronic device, or from personal accounts accessible on the electronic device such as accounts of social websites, data synchronization accounts, or the like.

An application running on the mobile device may be used to register and recognize still images from the environment. These images may be sent through the network to a recognition unit of a cloud service. This recognition unit may for example match the visual information in the transferred images with the content stored in a media storage. The media storage may for example be the personal media storage of a family. The matching items may be submitted to a context unit, which delivers a rated list of related content. A rating algorithm may calculate the best match for the submitted image and delivers the media to the mobile device. The application in the mobile device may receive the media stream and combine it with the real-time feed from the camera, rendering the video feed in the place of the original image in such way that it appears to the user like the video is playing in the physical frame containing the original image.

A system for context-sensitive organization of media files may comprise the cloud server system (cloud service) as described above and multiple electronic devices as described above. The system may for example be a networked system with storage and computing capabilities (cloud storage and computing), with a context unit and a media recognition unit running in said computing infrastructure, with a content delivery capability from the networked storage and with at least one mobile device with a display and real-time media capture capabilities.

Embodiments of methods of determining trends in picture taking activity are now described in more detail with reference to the accompanying drawings.

### Cloud Service and Respective Method for Providing a ‘See-Through’ Camera Mode

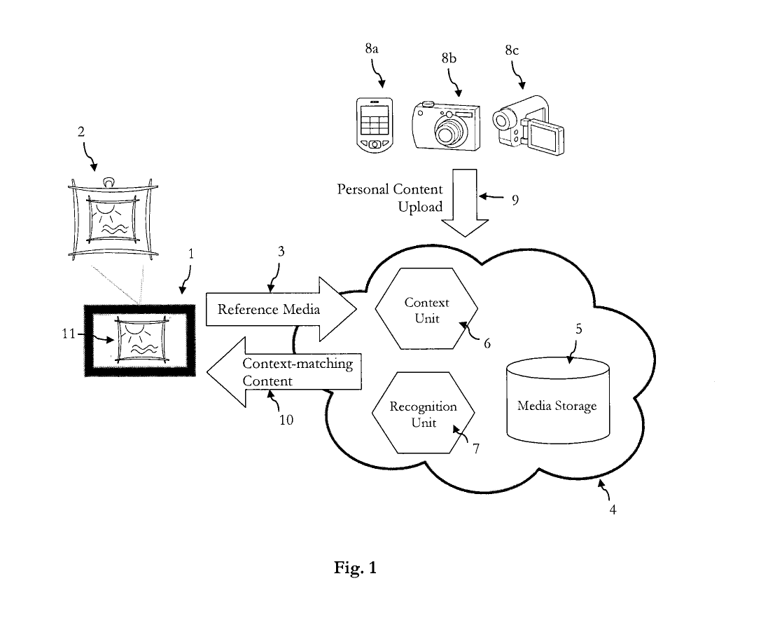

FIG. 1 schematically shows an embodiment of a system for context-sensitive organization of media files. In this embodiment a cloud service and respective method for providing a ‘see-through’ camera mode is provided. The system of this embodiment comprises a mobile device 1, here a tablet computer with integrated camera and networking capabilities. Mobile device 1 is equipped with a controller which runs an application program which provides a ‘see-through’ mode. In this ‘see-through’ mode a user of the mobile device 1 captures a digital still image of framed photo 2 which is hanging on the wall of the user's home. The digital still image of framed photo 2 will be used to determine a context. As depicted by arrow 3 the mobile device 1 has the capability of transmitting captured media files like the digital photo of still image 2 to a cloud service 4 via a network, e.g. via WI-FI connection and Internet connection. The application program delivers the captured digital still image of framed photo 2 to the cloud service 4 as a reference image in order to define a reference context.

The cloud service 4 comprises a media storage 5, a context unit 6 and a recognition unit 7. The media storage 5 stores media files which have been uploaded by many devices 8a, 8b, 8c attributed to the family of the user of mobile device 1, e.g. mobile phone 8a, point-and-shoot camera 8b and video camera 8c. The uploading of such media files to the cloud service is depicted by arrow 9. Such uploading has happened in the past and happens constantly whenever a family member produces a media file with one of the many devices 8a, 8c, 8c. Whenever a media file is uploaded to the cloud service, context unit 6 analyses the uploaded media file to determine context information related to the uploaded media file. Each context information determined by context unit 6 is stored alongside the respective media file in the media storage 5 of the cloud service 4 or in a separate context database.

When the digital still image of framed photo 2 is transmitted to the cloud service 4 as reference image, recognition unit 7 determines reference context information by performing image matching between the digital still image of framed photo 2 (reference image) obtained from mobile device 1 and media files stored in the media storage 5 of cloud service. By this image matching, one or more image-matching media files are obtained. The context information of the obtained image-matching media files is assumed to be also descriptive for the reference image, i.e. for the digital still image of framed photo 2. Reference context information is thus determined based on the context information of the obtained one or more image-matching media files.

Recognition unit 7 then matches the reference information thus obtained with context information of other media files stored in the media storage 5 to determine context-matching media files. The context-matching media files may then be rated by means of a rating algorithm to determine best-matching media files.

In this embodiment, a single best-matching video file is selected from best-matching media files based on the rating obtained by the rating algorithm. This video is considered as best-matching content from media storage 5 which is correlated with the digital still image of framed photo 2. As indicated by arrow 10 this video is then transmitted to the mobile device 1. The application program on the mobile device 1 uses the received video in the ‘see-through mode’ to enhance the visual appearance of the digital still image of framed photo 2 when displaying this digital image on mobile device 1. To this end, the application program renders the received video file on the electronic device in place of a digital still image of framed photo 2 in such way that it appears to the user of the electronic device like the video is playing in the physical frame 11 of framed photo 2.

This embodiment may be helpful in the following use case in which a mobile device is provided with a ‘see through’ mode.

During their holidays at the beach, the Nielsen family took (with mobile devices 8a, 8b, 8c of FIG. 1) plenty of still images and digital videos of their kids playing in the shore, building sand castles and trying bodysurfing. Back at home after the holidays, Marco, father of the family uploads (arrow 9 in FIG. 1) all captured media files to their personal content cloud (cloud service 4 of FIG. 1). Then he and his wife, Andrea, decide on few pictures to frame, one of the videos that captured their kids playing had a great light and they decide to extract a frame from the video and use it as a picture as well. They framed their pictures and hanged them proudly on the wall (image 2 of FIG. 1). A few months later, the Nielsen family get a visit from friends. During dinner, they talk about their past holidays and once they are done eating, they go for drinks to the living room where the pictures of the holiday are hanging. Marco takes his tablet (mobile device 1 in FIG. 1) and points the camera in the ‘see through’ mode to one of the pictures (image 2 of FIG. 1) where the kids are bodysurfing. After a moment of processing, the wall frame, as observed through the tablet starts to play the video of the kids surfing.

Later on, the Nielsen family shows their guests a printed album of the holidays. By pointing the tablet (mobile device 1 in FIG. 1) to the images in the album (image 2 of FIG. 1), the images in the album are brought ‘alive’ with digital footage related to the events depicted.

This all happens in this embodiment without any hassle from finding files among the huge amounts of pictures and videos that the Nielsen family have collected along the years (in media storage 5 of cloud service 4 in FIG. 1).

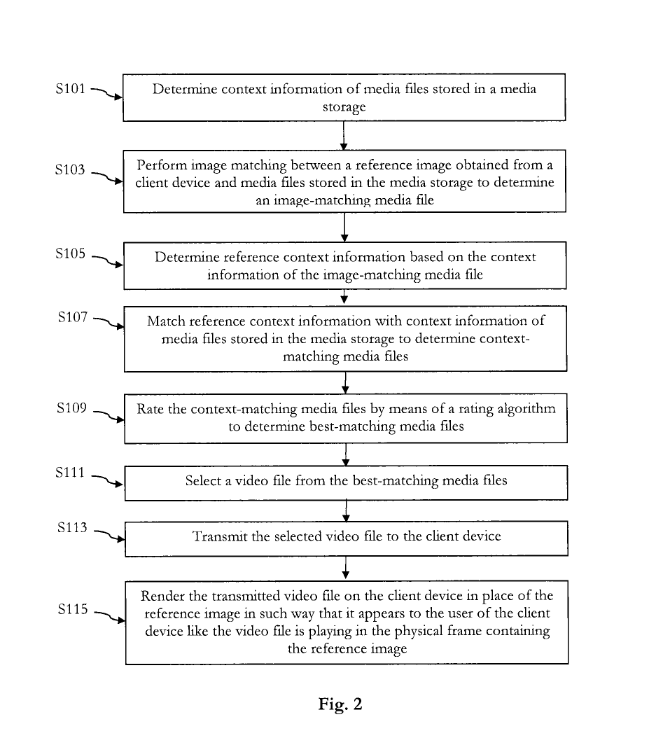

FIG. 2 schematically shows an embodiment of a method for context-sensitive organization of media files. This embodiment relates to the above-described ‘see-through’ mode of a camera device. At S101, it is determined context information of media files stored in a media storage. At S103, image matching is performed between a reference image obtained from an electronic device and media files stored in the media storage to determine an image-matching media file. At S105, reference context information is determined based on the context information of the image-matching media file. At S107, the reference context information is matched with context information of media files stored in the media storage to determine context-matching media files. At S109, the context-matching media files are rated by means of a rating algorithm to determine best-matching media files. At S111, a video file is selected from the best-matching media files. At S113, the selected video file is transmitted to the electronic device. At S115, the transmitted video file is rendered on the electronic device in place of the reference image in such way that it appears to the user of the electronic device like the video file is playing in the physical frame containing the reference image.

It should be noted that although S101 is displayed as first step in FIG. 2, S101 may happen at arbitrary points in time before, during, or after performing S103-S115. S105 and S107 may make use of all reference information available when performing S105 and/or S107.

It should also be noted that even though S107 and S109 are shown as separate entities, S107 and S109 might be considered and implemented as a single entity performing matching and rating at the same time.

### Image Matching

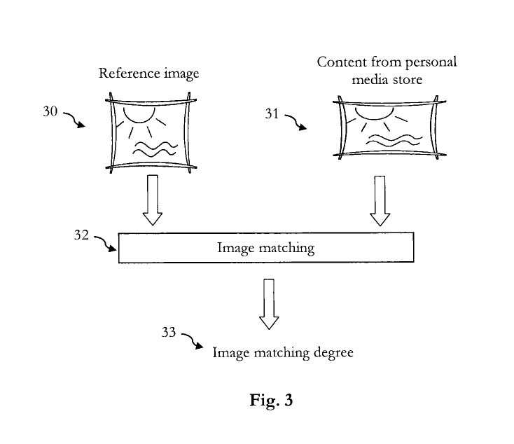

FIG. 3 schematically shows an image matching process which may be used in generating reference context information from a reference image. A reference image 30 is compared with content of the media storage. To this end an image matching 32 is performed between reference image 30 and each media file 31. In this embodiment the image matching 32 results in an image matching degree 33 for some or each media file 31 in the media store. Each image matching degree 33 is descriptive for the amount of image matching between the reference image 30 and the respective media file 31. The image matching may be performed with any method of image matching known to the skilled person. The image matching degree 33 can be used to determine whether or not the tested media file from the media store has similarities with the reference image, and if so, decide that context information of the tested media file may be used to describe a reference context which relates to reference image 30.

A similar image matching process may be used in generating context graphs of the content stored in a media store. For example, media files which are similar may be judged to relate to the same context so that context information of such media files may be exchanged, and/or such media files might be grouped together, for example as relating to the same event.

Matching of Reference Context Information with Context Information of a Media File

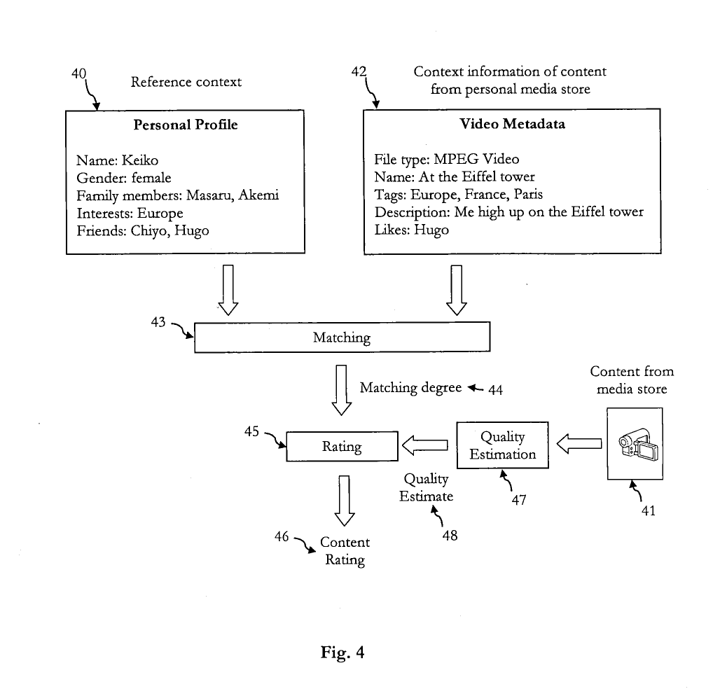

FIG. 4 schematically shows an embodiment of the matching of reference context information with context information of a media file from a media store.

In this embodiment, personal profile information 40 of Keiko is used as reference context information. The personal profile information 40 includes Keiko's name and gender, i.e. female. The personal profile information 40 further identifies two further members of Keiko's family, namely husband Masaru and daughter Akemi. The personal profile information 40 further states that Europe is among Keiko's interests. The personal profile information 40 also states that Keiko is connected to two friends, namely Chiyo and Hugo.

This reference context information is matched with context information of content from the personal media store. In this example the content is a video file 41 which is associated with metadata 42 defining a context for video file 41. The metadata 42 describes that the file is a MPEG video, that the name of the video file is “At the Eiffel tower”, and that the video is tagged with the keywords “Europe”, “France”, and “Paris”. The metadata 42 further includes a description which was manually added to the video and which states “Me high up on the Eiffel tower”. The metadata 42 further indicates that the video is liked by Hugo.

The matching is in this embodiment based on string comparisons between the elements of the personal profile information 40 and the metadata 42 of the video file. This string comparison will result in a match between the ‘Europe’ tag in metadata 42 and the ‘Europe’ interest identified in Keiko's personal profile information 40.

The matching 43 results in a matching degree 44. This matching degree may for example be determined by counting the number of element matches found in the matching process. The element matches might be weighted with predetermined weights. For example a match between a content file tag with personal interests might be weighted higher than a match between other entities. A rating 45 is performed based on the matching degree 43. This rating 45 results in a content rating 46 which reflects the degree of matching between the reference context information 40 and the context information 42 of video file 41. In this embodiment also a quality estimation 47 is performed on video file 41 in order to determine a quality estimate 48. This quality estimate 48 may be included into the rating 45. Quality estimation 47 uses procedures which are known to the skilled person in order to determine the blurriness, the exposure and the ISO noise level of a photo and combines the determination results in combined quality estimate 48.

In FIG. 4 the matching 43 and the rating 45 are depicted as two separate entities. However, these two entities can also be understood and implemented as one single entity which does matching and rating one after another, or at the same time, or in relation with each other.

Further, the rating 45 might also be based directly on information from the content file 42. For example the rating 45 may take into account that Hugo likes the video 41 and thus increase the rating of the video file accordingly.

### Cloud Service and Respective Method for Automatically Generating Media Albums

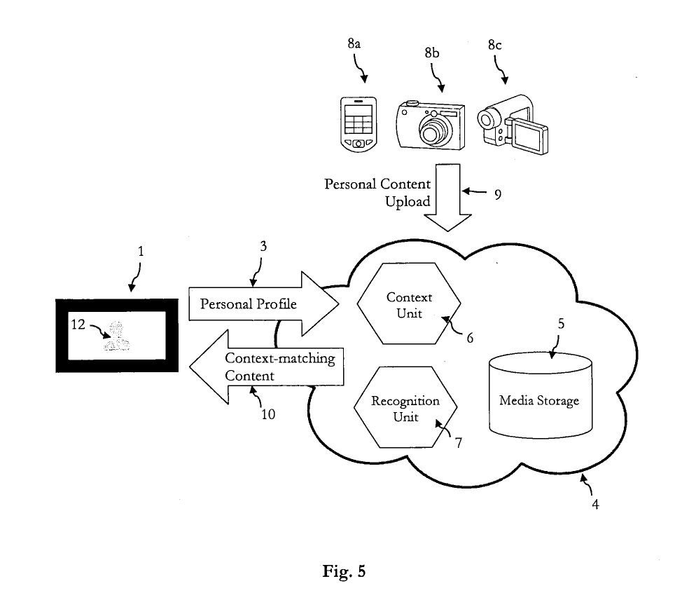

FIG. 5 schematically shows a further embodiment of a system for context-sensitive organization of media files. In this embodiment a cloud service and respective method for automatically generating media albums is provided. The system of this embodiment comprises a mobile device 1, here a tablet computer with integrated camera and networking capabilities. Mobile device 1 is equipped with an application program which provides an automatic generating of media albums. In this application a user of the mobile device 1 chooses a personal profile 12 of a friend on a social website. The application program retrieves personal profile information such as name, gender, hobbies, and likes of the selected friend from this social website to determine a context. As depicted by arrow 3 the mobile device 1 has the capability of transmitting the personal profile information to a cloud service 4 via a network, e.g. via WI-FI connection and Internet connection. The application program delivers the personal profile information to the cloud service 4 as a reference context information in order to define a reference context.

As in the previously described embodiments, the cloud service 4 comprises a media storage 5, a context unit 6 and a recognition unit 7. The media storage 5 stores media files which have been uploaded by many devices 8a, 8b, 8c attributed to the family of the user of mobile device 1, e.g. mobile phone 8a, point-and-shoot camera 8b and video camera 8c. The uploading of such media files to the cloud service is depicted by arrow 9. Such uploading has happened in the past and happens constantly whenever a family member produces a media file with one of the many devices 8a, 8c, 8c. Whenever a media file is uploaded to the cloud service 4, context unit 6 analyses the uploaded media file to determine context information related to the uploaded media file. Each context information determined by context unit 6 is stored alongside the respective media file in the media storage 6 of the cloud service 4 or in a separate context database.

When the personal profile information is transmitted to the cloud service 4 as reference context, recognition unit 7 determines reference context information based on the personal profile information.

Recognition unit 7 then matches the reference information thus obtained with context information of other media files stored in the media storage 5 to determine context-matching media files. The context-matching media files may then be rated by means of a rating algorithm to determine best-matching media files.

In this embodiment, a predefined number of best-matching media files is selected from the best-matching media files based on the rating obtained by the rating algorithm. These best-matching media files are considered as best-matching content for generating a media album. As indicated by arrow 10 the selected best-matching media files are transmitted to the mobile device 1. The application program on the mobile device 1 uses the received best-matching media files to display an automatically generated media album to the user of tablet computer 1.

This embodiment may be helpful in the following use case in which a mobile device is provided with an application program which enables an automatic generation of media albums.

Chiyo expects a visit of her friend Keiko for this evening. Chiyo decides that it would be nice to enjoy pictures with Keiko. An application for automated and context-sensitive generating a media album will help Chiyo to spend a nice evening with Keiko. To prepare the evening Chiyo starts this application on her tablet computer (1 in FIG. 5). The application provides a mode called ‘intelligent photo album’. The application is connected to a social website and, after choosing the option ‘enjoy photos with friend’, presents Chiyo a list of her friends on the social website. Chiyo chooses Keiko (12 in FIG. 5) from this list. The application detects personal information of Keiko stored on the social website and generates personal profile information from this information. The personal information on the social site may for example state that Keiko attended and liked a birthday party which took place last week. The personal information retrieved from the social website may further state that Keiko is married with husband Masaru and that Keiko has a daughter called Akemi. The application may also use further personal information retrieved for example from Keiko's electronic address book stored on her tablet computer or in the cloud to automatically generate the photo album for Keiko. The personal profile information of Keiko is transmitted to the cloud. After a moment of processing, a media album appears in the media gallery of Chiyo's tablet computer. Keiko and Chiyo together browse through this media album. The media album presents photos of Keiko and also of her husband Masaru and her daughter Akemi. The media album also presents some photos of the party Keiko attended last week. The media album presents photos with good quality and ignores any blurry photos of this party, or photos of otherwise bad quality available in Chiyo's personal cloud storage. The media album also avoids selecting two photos from the cloud which are to a large extent similar. In such case only one photo of the similar photos is selected to be part of the presented media album. The media album also contains some photos of Hugo. This is because during Keiko's last visit, Keiko liked photos of Hugo and indicated this by pressing a like′ button when viewing these images. The media album further presents some photos Chiyo made during her latest trip to France. This is because the personal profile information of Keiko indicates that she loves Europe. In particular, the media album presents some photos of Nice which are popular among other friends of Chiyo and thus obtained a lot of ‘views’ and ‘likes’ on the social website.

During the presentation of the automatically generated album, Keiko indicates to the application program that she wants to see ‘more like this’ concerning the photos Chiyo made during her visit to France. Additional photos from the cloud storage related to Chiyo's trip to France are thus retrieved from the personal media store and added to the album for presentation to Keiko and Chiyo.

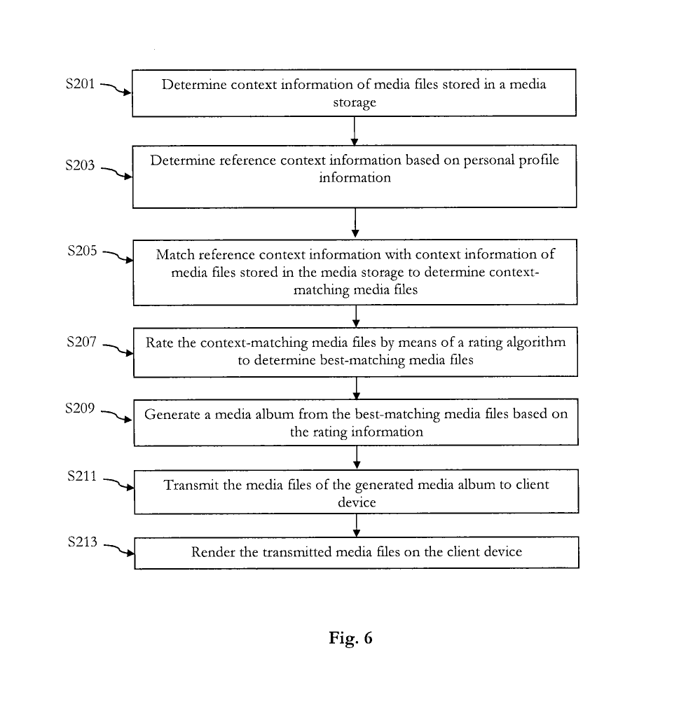

FIG. 6 schematically shows an embodiment of a method for context-sensitive organization of media files. This embodiment relates to the above-described automatic generation of media albums. At S201, it is determined context information of media files stored in a media storage. At S203, reference context information is determined based on personal profile information. At S205, the reference context information is matched with context information of media files stored in the media storage to determine context-matching media files. At S207, the context-matching media files are rated by means of a rating algorithm to determine best-matching media files. At S209, a media album is generated from the best-matching media files based on the rating information. At S211, the media files of the generated media album are transmitted to the electronic device. At S213, the transmitted media files are rendered on the electronic device.

It should be noted that although S201 is displayed as first step in FIG. 6, S201 may happen at arbitrary points in time before, during, or after performing S203-S113. S205 may make use of all reference information available when performing S205. It should also be noted that even though S205 and S207 are shown as separate entities, S205 and S209 might be considered and implemented as a single entity performing matching and rating at the same time.

### Cloud Service and Respective Method for Providing a Semantic Media Search

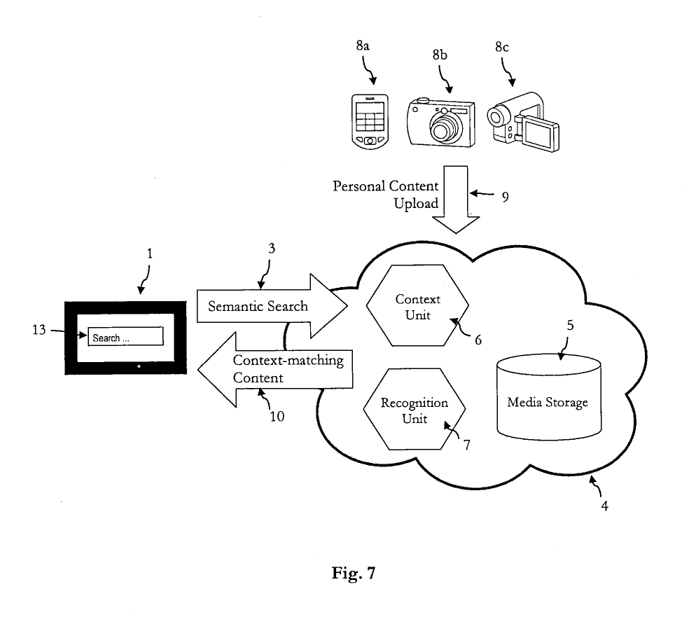

FIG. 7 schematically shows a further embodiment of a system for context-sensitive organization of media files. In this embodiment a cloud service and respective method for providing a semantic media search is provided. The system of this embodiment comprises a mobile device 1, here a tablet computer with integrated camera and networking capabilities. Mobile device 1 is equipped with an application program which provides a semantic media search. In this application a user of the mobile device 1 enters, by means of a touch keyboard, a search query into a search field 13. As depicted by arrow 3 the mobile device 1 has the capability of transmitting the search query to a cloud service 4 via a network, e.g. via WI-FI connection and Internet connection. The application program delivers the search query to the cloud service 4 as a reference context information in order to define a reference context.

As in the previously described embodiments, the cloud service 4 comprises a media storage 5, a context unit 6 and a recognition unit 7. The media storage 5 stores media files which have been uploaded by many devices 8a, 8b, 8c attributed to the family of the user of mobile device 1, e.g. mobile phone 8a, point-and-shoot camera 8b and video camera 8c. The uploading of such media files to the cloud service is depicted by arrow 9. Such uploading has happened in the past and happens constantly whenever a family member produces a media file with one of the many devices 8a, 8c, 8c. Whenever a media file is uploaded to the cloud service 4, context unit 6 analyses the uploaded media file to determine context information related to the uploaded media file. Each context information determined by context unit 6 is stored alongside the respective media file in the media storage 6 of the cloud service 4 or in a separate context database.

When the search query is transmitted to the cloud service 4 as reference context, recognition unit 7 determines reference context information based on the search query. The search query may for example be used by recognition unit 7 to define a semantic search.

Recognition unit 7 then matches the reference information thus obtained with context information of other media files stored in the media storage 5 to determine context-matching media files. The context-matching media files may then be rated by means of a rating algorithm to determine best-matching media files.

In this embodiment, a predefined number of best-matching media files is selected from the best-matching media files based on the rating obtained by the rating algorithm. These best-matching media files are considered as best-matching content for returning a significant search result. As indicated by arrow 10 the selected best-matching media files are transmitted to the mobile device 1. The application program on the mobile device 1 uses the received best-matching media files to display, as result of the search query, an automatically generated media stream to the user of tablet computer 1.

This embodiment may be helpful in the following use case in which a mobile device is provided with an application program which enables a semantic media search.

Chiyo decides to watch some photos on her tablet computer (1 in FIG. 7). Chiyo believes that it would be nice to see some photos of her last trip to France. She opens the search application and enters the terms ‘Photos I took during my holidays in France’ into a search field (13 in FIG. 7). This search query is transmitted to the cloud (4 in FIG. 7). After a moment of processing a media album appears in the media gallery of Chiyo's tablet computer. The media album presents photos Chiyo took during her last visit to France. The media album presents photos with good quality and ignores any blurry photos of this visit, or photos of otherwise bad quality available in Chiyo's personal cloud. The media album also avoids selecting two photos from the cloud which are to a large extent similar. In such case only one photo of the similar photos is selected to be part of the presented media album. The media album also contains some photos of Nice which are popular among friends of Chiyo and thus obtained a lot of ‘views’ and ‘likes’ on the social website.

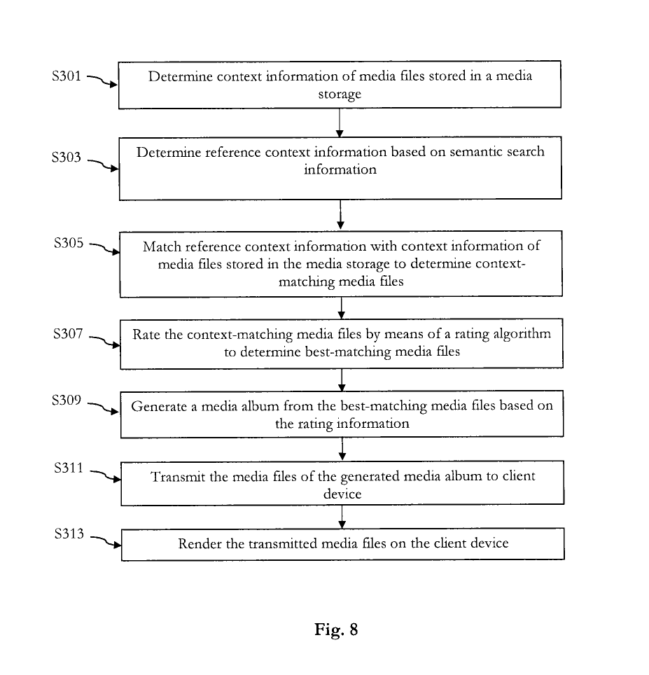

FIG. 8 schematically shows an embodiment of a method for context-sensitive organization of media files. This embodiment relates to the above-described semantic search. At S301, it is determined context information of media files stored in a media storage. At S303, reference context information is determined based on semantic search information. At S305, the reference context information is matched with context information of media files stored in the media storage to determine context-matching media files. At S307, the context-matching media files are rated by means of a rating algorithm to determine best-matching media files. At S309, a media album is generated from the best-matching media files based on the rating information. At S311, the media files of the generated media album are transmitted to the electronic device. At S313, the transmitted media files are rendered on the electronic device.

It should be noted that although S301 is displayed as first step in FIG. 8, S301 may happen at arbitrary points in time before, during, or after performing S303-S313. S305 may make use of all reference information available when performing S305. It should also be noted that even though S305 and S307 are shown as separate entities, S305 and S309 might be considered and implemented as a single entity performing matching and rating at the same time.

Mobile Device for Use with Context-Enhanced Cloud Services

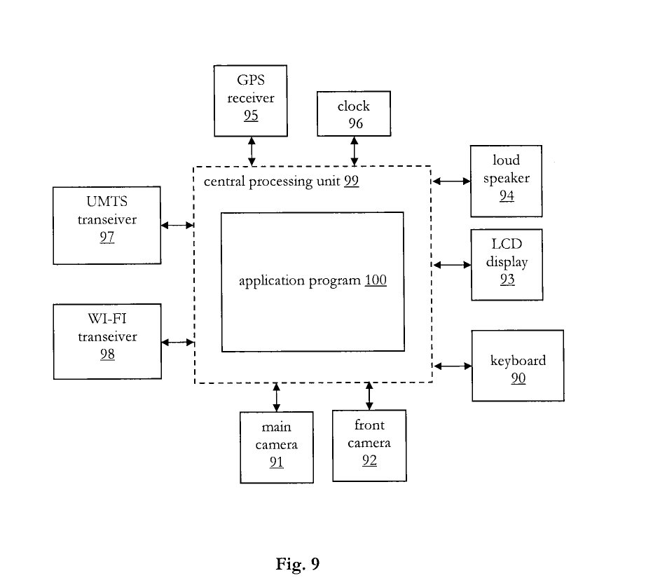

FIG. 9 schematically shows an embodiment of an electronic device for use with the above-described context-enhanced cloud services. The electronic device of this embodiment is a mobile device which comprises a keyboard 90 for entering text and commands, a main camera 91 (backside camera) and an additional front camera 92 for capturing pictures, a LCD display 93, a loud speaker 94, a GPS receiver 95, a clock 96, an UMTS transceiver 97 and a WI-FI transceiver 98. The electronic device further comprises, as a processing device, a central processing unit 99 which is running an application program 100. This application program 100 is in communication with the main camera 91 and the front camera 22 for capturing pictures from the data sensed by the main camera 91 and/or the front camera 22. The application program 100 further is in communication with the GPS receiver 95 and the clock 96 for determining the geographic location and time of picture capture, and for associating this information with the taken picture as context information. The application program 100 further is in communication with the UMTS transceiver 97 and the WI-FI transceiver 98 for uploading pictures taken with the main camera 21 and associated metadata to a cloud service. The application program 100 further is in communication with the UMTS transceiver 97 and/or the WI-FI transceiver 98 for receiving media files from a cloud service.

The application program 100 is configured to determine reference context information, to context-match the reference context information with context information of media files to obtain a context-matching media file.

The application program 100 is in communication with the UMTS transceiver 97 and the WI-FI transceiver 98 to enable uploading reference context information to a cloud service, and to receive context-matching media files from the cloud service, the received context-matching media files being context-matched by the cloud service with the reference context information uploaded.

The application program 100 further is in communication with the LCD display 93 to render the context-matching media file on the LCD display 93. In particular, the application program 100 is capable of rendering a received video file on the LCD display 93 in place of a reference image in such way that it appears to the user of the electronic device like the video is playing in the physical frame containing the reference image.

In addition the application program 100 is configured to determine reference context information by receiving semantic search information from keyboard input. To this end, the application program 100 is configured to present a search field to the user. The user may use keyboard 90 to enter search terms to define a semantic search pattern. The semantic search pattern may then be used as reference context information to determine context-matching media files.

The application program 100 is further configured to determine reference context information from personal profile information. The personal profile information might for example be retrieved from an address book available on the electronic device, or from personal accounts accessible on the electronic device such as accounts of social websites, data synchronization accounts, or the like.

The application program 100 running on the mobile device may be used to register and recognize still images captured by main camera 91 from the environment. These images may be sent via UMTS transceiver 97 or WI-FI transceiver 98 to a cloud server.

The application program 100 is further in communication with the front camera 92 in order to capture pictures of persons which are using the electronic device while viewing media files on LCD display 93 or while taking pictures with the main camera 91. The application program 100 is further configured to determine from the images taken with front camera 92 the mood of the person or persons which are using the electronic device while viewing media files on LCD display 93 or while taking pictures with the main camera 91.

The application program 100 is further in communication with loud speaker 94 for capturing ambient noise and/or sound while pictures are taken with the main camera 91. The application program 100 is configured to determine context information related to the captured media files from noise or sound captured by loud speaker 94. The application program 100 is further configured to associate such context information with captured media files.

The electronic device may be a mobile device, such as a mobile phone, tablet computer, camera device, wearable computing device, or notebook computer. Alternatively, the electronic device might be a desktop computer or a workstation or any other computing client.

All units and entities described in this specification and claimed in the appended claims can, if not stated otherwise, be implemented as integrated circuit logic, for example on a chip, and functionality provided by such units and entities can, if not stated otherwise, be implemented by software.

It is thus disclosed in this specification:

[1] A method comprising

determining context information of at least one media file stored in a media storage, and

matching reference context information with the context information to determine at least one context-matching media file.

[2] The method of [1], further comprising rating the at least one context matching media file based on at least one parameter related to the quality of the at least one media file
[3] The method of anyone of [1] or [2], in which the reference context information is obtained by

performing image matching between a reference media file obtained from an electronic device and the at least one media file to obtain at least one image-matching media file; and

determining the reference context information based on context information of the at least one image-matching media file.

[4] The method of [3], in which the reference media file is a still image, the method further comprising rating the at least one context-matching media file by means of a rating algorithm to determine at least one best-matching media file, and selecting a video file from the at least one best-matching media file.
[5] The method of [4], further comprising rendering the video file on the electronic device in place of the reference image in such way that it appears to the user of the electronic device like the video file is playing in a physical frame containing the reference image.
[6] The method of anyone of [1] to [5], further comprising rating the at least one context-matching media file by means of a rating algorithm to determine at least one best-matching media file, and generating a media album from the at least one best-matching media file.
[7] The method of anyone of [1] to [6], in which the reference context information comprises personal profile information, and in which the matching reference context information with context information comprises matching personal profile information with the context information.
[8] The method of anyone of [1] to [7], in which the reference context information comprises semantic search information, and in which the matching reference context information with context information comprises matching semantic search information with the context information.
[9] The method of anyone of [1] to [8], in which determining context information of at least one media file comprises determining location information, time information, rating information, privacy levels, media descriptions, media tags, information about the producer of a media file, preference information, or information about camera settings.
[10] The method of anyone of [1] to [9], in which determining context information of at least one media file comprises determining information about the sharing of the media files on social sites.
[11] The method of anyone of [1] to [10], in which determining context information of at least one media file comprises determining information about the sharing of the media files in real life.
[12] The method of anyone of [1] to [11], in which determining context information of at least one media file comprises determining information about the mood of the person who produced a media file.
[13] The method of anyone of [1] to [12], in which determining context information of at least one media file comprises recognizing features of the content of a media file and determining information about such recognized features.
[14] The method of anyone of [1] to [13], further comprising determining a contextual relationship between the at least one media file stored in the media storage.
[15] A cloud server system comprising

a media storage configured to store at least one media file;

a context unit configured to determine context information of the at least one media file; and

a recognition unit configured to match reference context information with the context information to determine at least one context-matching media file.

[16] An electronic device comprising a display and a controller, the controller being configured

to determine reference context information;

to receive at least one context-matching media file which has been obtained by matching the reference context information with context information of at least one media file; and

to render the at least one context-matching media file on the display device.

[17] The electronic device of [16], in which the controller is configured

to upload the reference context information to a cloud server system, and

to receive the at least one context-matching media file from the cloud server system, the received at least one context-matching media file being context-matched by the cloud server system with the reference context information uploaded to the cloud service system.

[18] The electronic device of [16] or [17], in which the controller is configured to render the at least one context-matching media file on the display in place of a reference media file in such way that it appears to the user of the electronic device like the context-matching media file is playing in the physical frame containing the reference media file.
[19] The electronic device of anyone of [16] to [18], which further comprises a keyboard and in which the controller is configured to determine the reference context information by receiving semantic search information from keyboard input.
[20] The electronic device of anyone of [16] to [19], in which the controller is configured to determine the reference context information from personal profile information.

The present application claims priority to European Patent Application 14 156 765.1, filed in the European Patent Office on 26 Feb. 2014, the entire contents of which being incorporated herein by reference.

1. A method comprising
determining context information of at least one media file stored in a media storage, and
matching reference context information with the context information to determine at least one context-matching media file.

2. The method of claim 1, further comprising rating the at least one context matching media file based on at least one parameter related to the quality of the at least one media file

3. The method of claim 1, in which the reference context information is obtained by
performing image matching between a reference media file obtained from an electronic device and the at least one media file to obtain at least one image-matching media file; and
determining the reference context information based on context information of the at least one image-matching media file.

4. The method of claim 3, in which the reference media file is a still image, the method further comprising rating the at least one context-matching media file by means of a rating algorithm to determine at least one best-matching media file, and selecting a video file from the at least one best-matching media file.

5. The method of claim 4, further comprising rendering the video file on the electronic device in place of the reference image in such way that it appears to the user of the electronic device like the video file is playing in a physical frame containing the reference image.

6. The method of claim 1, further comprising rating the at least one context-matching media file by means of a rating algorithm to determine at least one best-matching media file, and generating a media album from the at least one best-matching media file.

7. The method of claim 1, in which the reference context information comprises personal profile information, and in which the matching reference context information with context information comprises matching personal profile information with context information.

8. The method of claim 1, in which the reference context information comprises semantic search information, and in which the matching reference context information with context information comprises matching semantic search information with the context information.

9. The method of claim 1, in which determining context information of at least one media file comprises determining location information, time information, rating information, privacy levels, media descriptions, media tags, information about the producer of a media file, preference information, or information about camera settings.

10. The method of claim 1, in which determining context information of at least one media file comprises determining information about the sharing of the media files on social sites.

11. The method of claim 1, in which determining context information of at least one media file comprises determining information about the sharing of the media files in real life.

12. The method of claim 1, in which determining context information of at least one media file comprises determining information about the mood of the person who produced a media file.

13. The method of claim 1, in which determining context information of at least one media file comprises recognizing features of the content of a media file and determining information about such recognized features.

14. The method of claim 1, further comprising determining a contextual relationship between the at least one media file stored in the media storage.

15. A cloud server system comprising
a media storage configured to store at least one media file;
a context unit configured to determine context information of the at least one media file; and
a recognition unit configured to match reference context information with the context information to determine at least one context-matching media file.

16. An electronic device comprising a display and a controller, the controller being configured
to determine reference context information;
to receive at least one context-matching media file which has been obtained by matching the reference context information with context information of at least one media file; and
to render the at least one context-matching media file on the display device.

17. The electronic device of claim 16, in which the controller is configured
to upload the reference context information to a cloud server system, and
to receive the at least one context-matching media file from the cloud server system, the received at least one context-matching media file being context-matched by the cloud server system with the reference context information uploaded to the cloud service system.

18. The electronic device of claim 17, in which the controller is configured to render the at least one context-matching media file on the display in place of a reference media file in such way that it appears to the user of the electronic device like the context-matching media file is playing in the physical frame containing the reference media file.

19. The electronic device of claim 16, which further comprises a keyboard and in which the controller is configured to determine the reference context information by receiving semantic search information from keyboard input.

20. The electronic device of claim 16, in which the controller is configured to determine the reference context information from personal profile information.
